(19) United States
(12) Patent Application Publication
(10) Pub. No.: US 2024/0320759 A1
(43) Pub. Date: Sep. 26, 2024

(54) SYSTEM AND METHOD FOR WEIGHTED PROFILE CONNECTION IN A NETWORK ENVIRONMENT

(71) Applicant: Amy April Gemme, Kettering, OH (US)

(72) Inventor: Amy April Gemme, Kettering, OH (US)

(21) Appl. No.: 18/126,397

(22) Filed: Mar. 25, 2023

(51) Int. Cl. G06Q 50/00; G06Q 10/1093; G06Q 30/02

(52) U.S. Cl. CPC G06Q 50/01; G06Q 10/1095; G06Q 30/02

(57) ABSTRACT

User profiles can be connected for various types of connections using computer systems. The computer system can identify a first and second value from each of a first and second profile. Based on the values, and using an algorithm, a comparison can be performed to result in a match score. This match score can be used to identify a match between the two profiles and in response an introduction can be facilitated between the two profiles resulting in a match.

### BACKGROUND

The present disclosure relates to computer-implemented connecting systems and methods, and more specifically, to systems and methods to for providing a weighted connection and matching processes in a networked environment.

Software applications for dating (“dating apps” or simply “apps”) are ever present in our global community and while they have been around since the 1990s, estimates indicate they have been successful in establishing relationship with under 20% of the population using them. While predictors of human compatibility are often hard to predict in advance of meeting, an entire industry has been built around developing effective and efficient approaches to building and fostering human connection.

Outside of the traditional dating sphere, human connection is increasingly facilitated with the assistance of data collection and digital tools. As more and more businesses are conducting daily operations online and the absence of an in-person element drive increasingly global workplaces, our traditional modes of human connection are evolving. However, with these changing global landscapes, the importance of human connection, for ones mental health, professional growth, and personal fulfillment has moved from the sidelines to core tenant amidst a diversity of cultures.

### SUMMARY

According to embodiments of the present disclosure are directed toward aa computer-implemented method for connecting two user profile. A computer system may identify a first value from a first user profile as well as identify a second value from a second user profile. The system may then use an algorithm to compare the first value with the second value. Based on the comparing, a match score may be determined and in response to the match score, an introduction between the first and second user profiles may be communicated.

Certain embodiments are directed toward a computer system comprising at least one processor circuit for connecting two user profiles. The computer system may have a profile generating module to identify a first and second value from a first and second user profile, respectively. The computer system may have a match type comparison module that can compare the first and second values using an algorithm. The system may also comprise a match score generating module which can determine a match score based on the comparison and based on the score, communicate an introduction between the first user profile and the second user profile.

Certain embodiments are directed toward a computer program product for connecting profiles. The computer program product comprising a computer readable storage medium with program instructions embodied therewith and the computer readable storage medium is not a transitory signal per se. The program instructions executed by a computer processing circuit to cause the circuit to perform a method. The method may identify a first value from a first user profile as well as identify a second value from a second user profile. The system may then use an algorithm to compare the first value with the second value. Based on the comparing, a match score may be determined and in response to the match score, an introduction between the first and second user profiles may be communicated.

The above summary is not intended to describe each illustrated embodiment or every implementation of the present disclosure.

### BRIEF DESCRIPTION OF THE DRA WINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

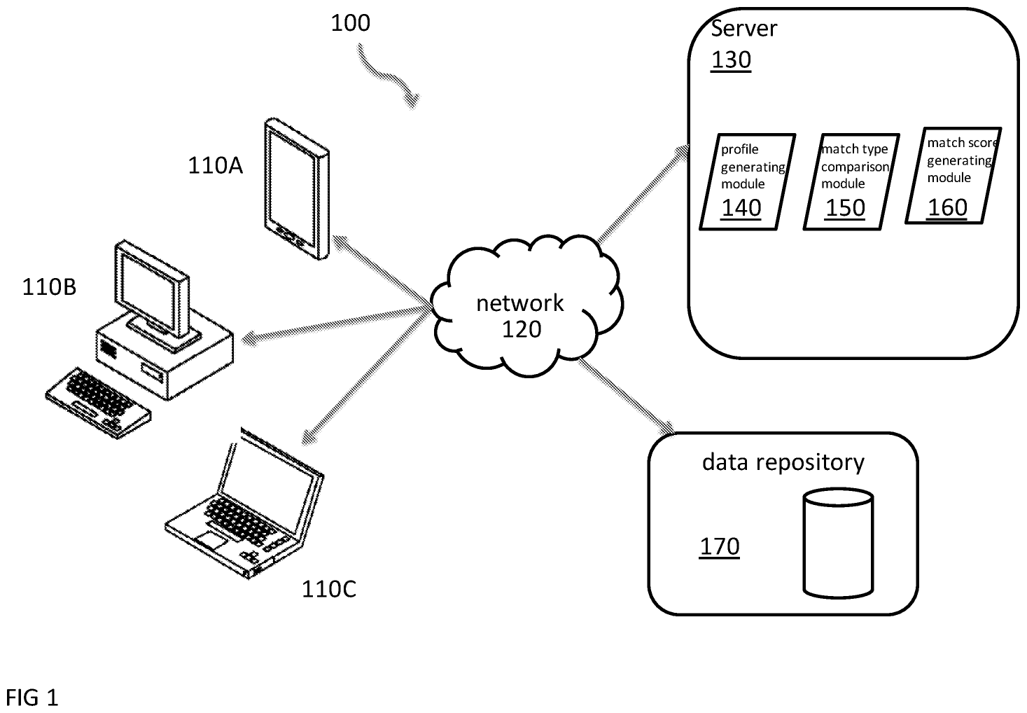

FIG. 1 depicts a simplified block diagram of a system 100 for a matching system in a networked environment for connecting users

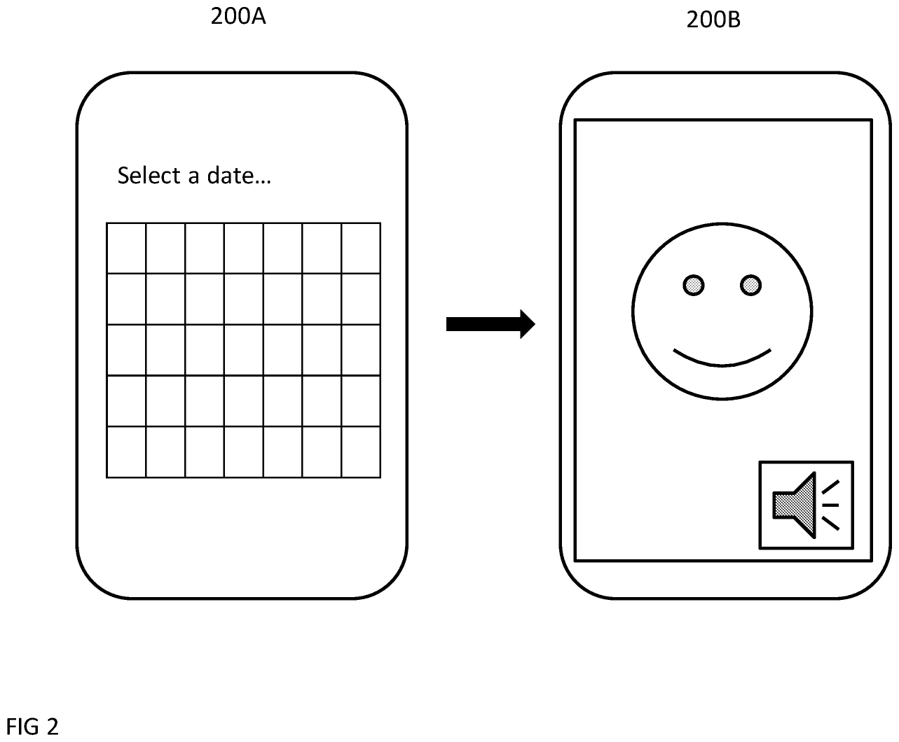

FIG. 2 depicts an example user interface to receive an input from a user, according to embodiments.

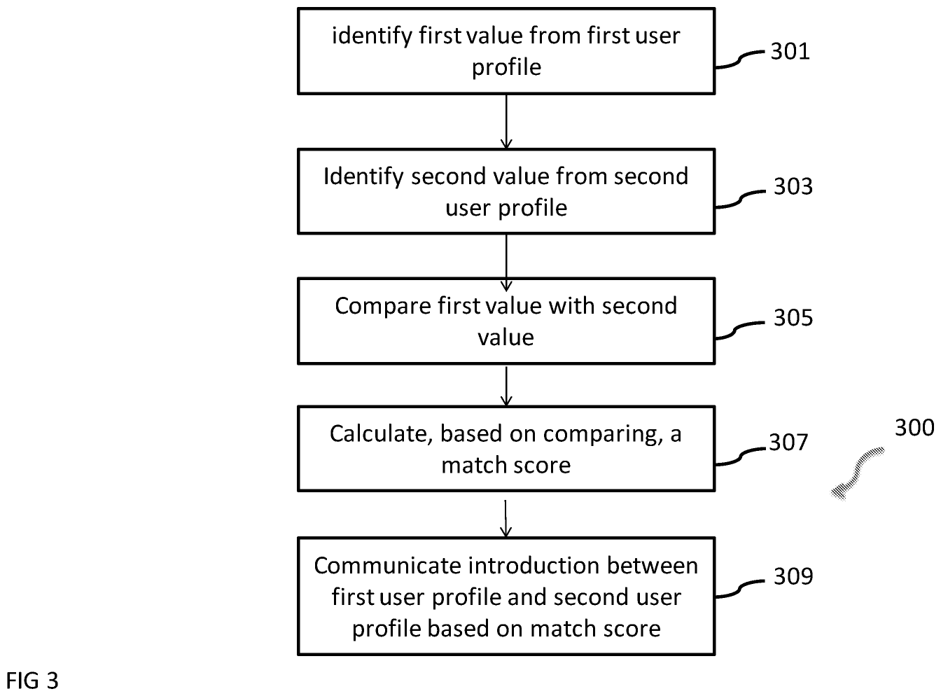

FIG. 3 depicts an example flow of the system for connecting profiles in a networked environment, according to embodiments.

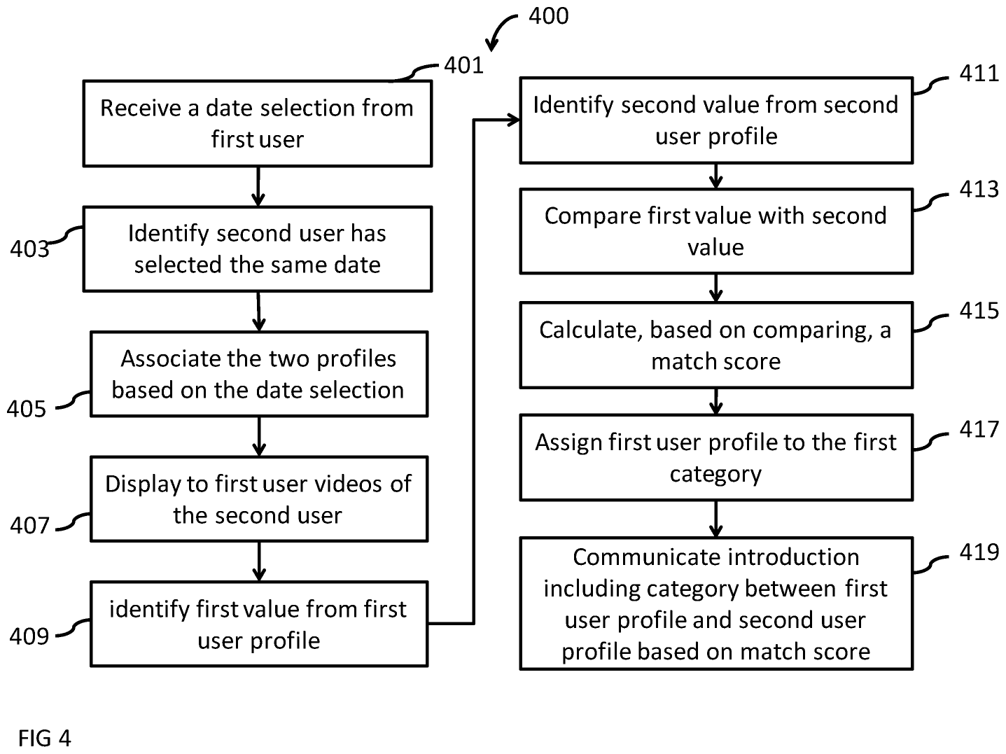

FIG. 4 depicts a detailed example flow of the system for connecting profiles in a networked environment, according to embodiments.

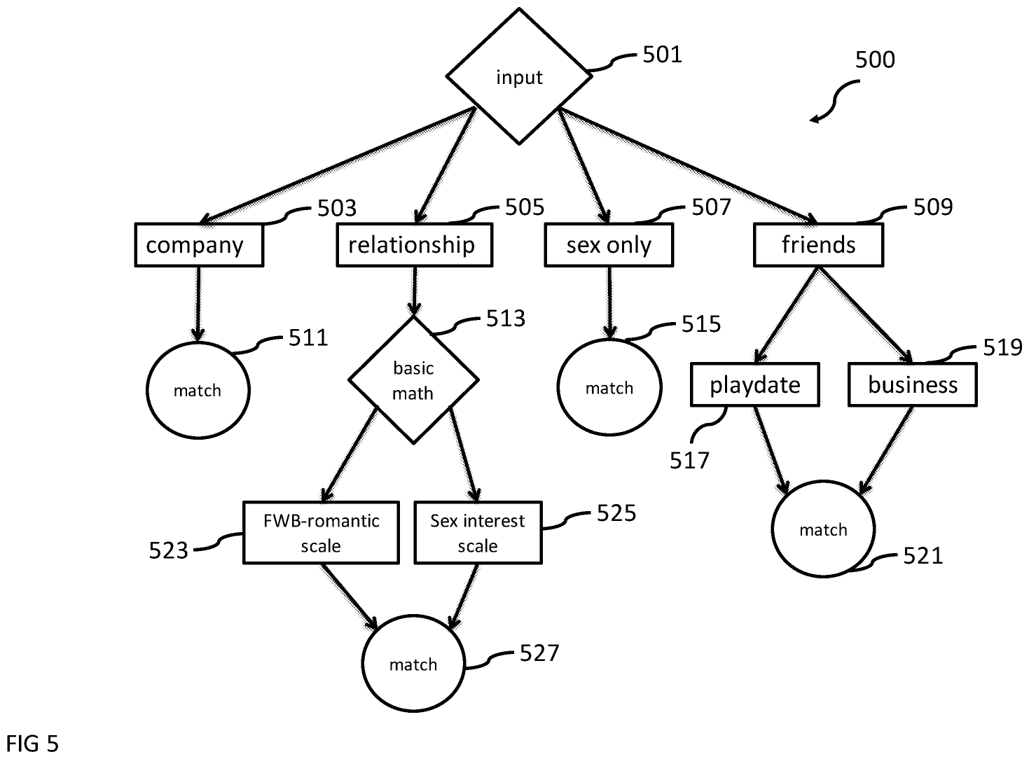

FIG. 5 depicts a flow of the algorithm for weighting and connecting profiles in a networked environment, according to embodiments.

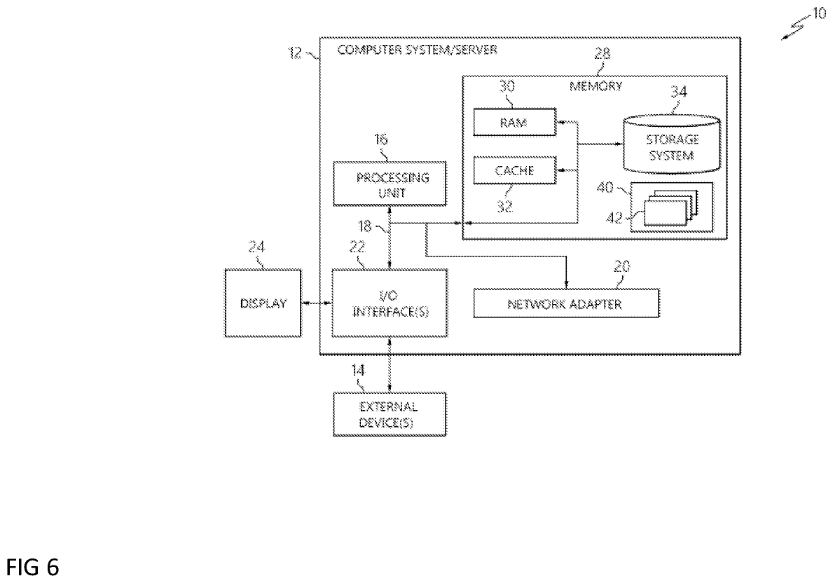

FIG. 6 depicts a cloud computing node, according to embodiments.

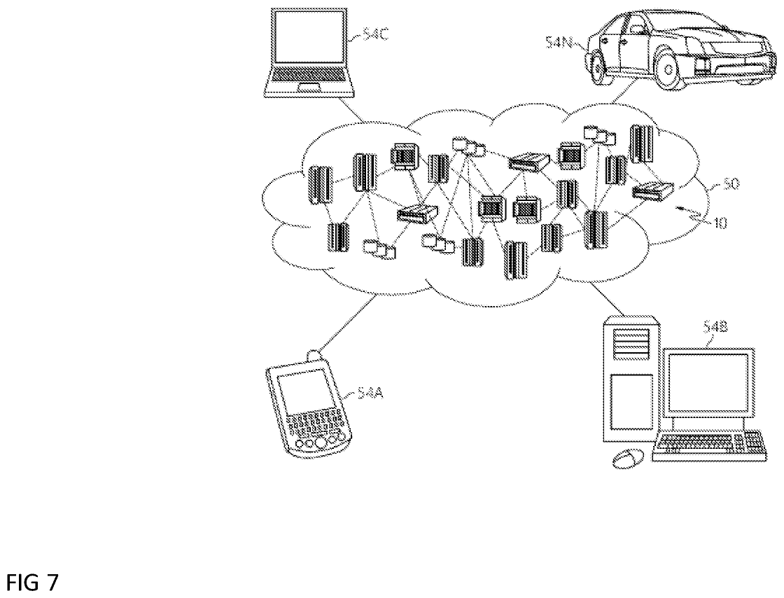

FIG. 7 depicts a cloud computing environment, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to computer matching systems, more particular aspects relate to matching processes and systems in a networked environment. While the present disclosure is not necessarily limited to such applications, various aspects of the disclosure may be appreciated through a discussion of various examples using this context.

Historically, dating apps provide a binary decision making process in establishing matches. For example, many apps allow a user to ‘swipe’ right or left as a decision making of ‘yes’ or ‘no’ to express interest in the profile presented. This, however, is not reflective of the complexity and multiplicity of human connection.

According to embodiments described herein, a human connection algorithm is developed and applied to various human connection scenarios to facilitate digital or “online” connections. In some embodiments, a social or more traditional dating attraction could be described. For example, types of attraction could include romantic, platonic, intellectual, emotional, physical, or potential long term commitment. In some embodiments, a business or professional connection could be preferred. In this case, examples could include, among others, expressions of interest in business collaboration, vendor relationships, mentoring opportunities, peer or knowledge sharing, work buddies, or presenter or public speaking interest. In embodiments, a parent-focused connection could be centered, wherein types of connection could include examples such as “play date” (i.e., arranged time and place for children to socialize), child care or child care swap, or other child or parent-related activities.

### Calendar

In social connection applications, a profile or group of profiles may be ‘matched’ with another profile or group of profiles, responsive to a correlation or other factor prescribed by the applications one or more algorithms. Oftentimes, this match will result in a mutual notification to each profile or group of profiles that a match has occurred. Based on various designs, one or more of the profiles will be enabled to begin messaging or communication with the other profile or group of profiles. Often, this match determination is made based on a set of similarity factors including age, appearance, interests, geographic location and others. However, very few ‘matches’ on dating applications lead to actual dates. In embodiments contemplated herein, an initial introduction is predicated on an overlap in availability or preferred dates for meeting up.

### Diverse Sign Ups

Additionally, many social connection apps require, as part of the signup and profile creation process to select a gender and/or sexual orientation with which you most identify. While many apps are beginning to include options for those who do not identify with the gender binary or wish to pursue same-gendered, polyamorous, or other types of connections, a gap exists for those looking to more precisely express their individual combination of body, gender, and connection preferences. Likewise, an option to remove identification and still participate is wholly lacking.

In embodiments described here, one or more selectable visuals is presented to the user as part of the sign up process, or at anytime the user wishes, for the user to set profile parameters to describe him/her/themselves as well as select the user's date preference. These selectable visuals (e.g., graphical user interfaces) may be the same or different, examples of which are explained in more detail herein. Users may also choose to decline to identify any gender or sexual-preference related information when creating a profile. By skipping that step entirely, they are enabled to choose a type of connection based on the individual profile being presented.

### Location Data Integration

Traditional apps may initiate a ‘match’ based on a location radius or require a particular location parameter as part of a match algorithm (e.g., select matches only within a 10 mile radius, select matches only within 4 km).

Embodiments of the proposed may match profiles based on, among other factors, profile availability, based on calendar selection as described herein or in another scheduling-focused manner. The location data integration feature may allow a user (as represented via a user profile) to invite (display the travel (e.g., drive, walk, transit commute) time in minutes and/or distances for each date or connection option (e.g., lunch time, coffee time, dinner time, night cap) the windows as the invite video plays.

In embodiments, location data may include a tighter scope, for example, rather than a city or neighborhood, it could use a conference or workplace venue. For example, at a conference, location data could be used to identify physical meeting room spaces in conference centers, cafes or bars near introduced users' profiles hotels, lunch or dinner engagements, or the like.

In an intracompany setting, location data could help to identify and connect interested users in finding physical spaces on campus like cafeterias, meeting rooms or buildings. For example, in a scenario where two users are interested in establishing a mentoring relationship, but on is located in the executive building and the other is located across the campus on the other side of an urban campus/city setup. In this case, location data pulled from calendars and historical data could identify a restaurant that both users frequent on a particular day of the week and recommend that as a location for a coffee conversation. The algorithm could also pull data that indicates that the executive will be in a neighboring building for a meeting later in the week, and could suggest an office location for that particular day, to increase convenience and reduce commuting time for both users.

### Safety Reminder

The app may include a feature to remind the user to share location data on the night of the date to a friend or other safe person. This feature, and others are described in more detail in the attached documentation.

In embodiments, the software application for connection or “connection app” or “dating app” described herein uses a matching of calendars or dating availability preferences as a first filter when determining whether or not a profile will be shown to a user. Assuming at least one or more calendar dates match, the user is then shown a set of profile videos for a set of users who have selected the same date(s). The user may input one or more responses to each of the videos, that can indicate an attraction or potential attraction according to categories described herein, for example, ‘company’, ‘a relationship’, ‘sex only’. In other situations, the user may provide input to show interest in connecting over types of relationships such as ‘playdate’ in a parenting context or ‘mentoring’ in a business context. The input provided by the user is then compared with input provided by the user reflected in the displayed profile. If the scores reach a particular threshold, in a set of thresholds, the users will be matched.

In some instances, a ‘match’ may only provide the users with an ability to schedule a meet up, for example, by completing a form that suggests a time and location. This form may be exchanged between the two users until both users indicate an agreement, for example, by a confirmation. In other cases, users may be able to correspond or ‘chat’ via one or more chat functions in the app. Once a date has been confirmed and the date passes, the users will no longer be ‘matched’ and it will be up to them to sort out their future communication. In other embodiments, the profiles may remain ‘matched’ within the app and have the ongoing ability to chat and message, unless one or more profile users choose to unmatch or block.

Turning now to the figures, in FIG. 1, one embodiment of the connecting system is shown. FIG. 1 is a simplified block diagram of a system 100 for a matching system in a networked environment for connecting users. The system may include the elements described herein, but it may also include various other configurations, as contemplated herein and by use of relevant technology. As mentioned herein, the matching system can be used to connect users in a traditional and non-traditional dating context, including many types of human connection. In other contexts, the system 100 may be used to connect across professional networks, conferences, parenting or other child-focused purposes, or many other purposes.

Users may interact with the system via user devices 110 A-C. For example, a user device may be a phone or tablet as shown at 110A, a desktop computer 110B, a laptop computer 110C, or another user device. Each user device may include a display and interface or an interactive UI to allow the user to view and interact with the system via the user device 110, on which any number of applications may be run, as described in later figures. Server 130 may be connected to user devices 110 via a network or set of one or more networks 120. The networks can include, but are not limited to, local area networks, point-to-point communications, wide area networks, the global Internet, and combinations thereof.

The server 130 may comprise one or more computer processing circuits, where the circuits may be configured to include the modules described herein. The system may include other modules than those described herein. The server 130 and modules of the server (modules 140-160) may be communicatively or physically coupled to a set of one or more data repositories 170. In some instances, the data repository 170 may be a part of the server 130. In other embodiments, they may exist entirely in the cloud.

A first user may interact with a user device 110 by submitting a video or set of short videos to the server 130 via the network 120. Responsive the receiving, a profile generating module 140 may generate a profile for the first user. The first user may also submit other relevant information including a name, gender, location, frequently visited locations, type of connection the user is looking for, or other biographical or non-biographical information. The user may also submit a date or set of dates and corresponding time or times. These dates and times may indicate preferences or availability “availability date” to connect with another user, including in-person, telephonic, video conference or video call, texting, in the metaverse, via VR, or any other type of desired connection. This information may be stored in a first profile for the first user.

At the same or another time, a second user may engage with the system 100 by inputting into the user device 110 similar profile information. This may be sent to the server 130 via the network 120. The profile generating module 140 may, responsive to receipt of this input, generate a second profile for the second user. These profiles may then be stored in the data repository 170, for current or future use. Based on predetermined criteria, the server with transmit for display on the device 110 used by the first user, the profile of the second user. In some instances, the predetermined criteria are an overlap between the availability date of the first user and the second user. Likewise, the second user will receive a display of the first user's profile, including the videos and select biographical and non-biographical information, based on the overlap or ‘match’ in availability dates. For example, the first user as selected June 1 for a date preference. If the second user also selects June 1, the first user may be shown videos submitted by the second user and vice-versa, with the second user receiving the first user's videos and video profile. In many instances, these videos may be short (only a few seconds) to longer (up to a minute), to extremely long, based on user preferences and different versions of the application.

At the same or different times, each user may input a value responsive to the other user's profile video. The first value from the first user may indicate a type of connection the first user would like with a second user. Likewise, the second value from the second user could indicate a similar but not same type of connection the second user would like with the first user. A match type comparison module 150 may then compare, using an algorithm, a first value in the first user profile with a second value in the second user profile. The algorithm may be, for example, the algorithm discussed in later figures. Based on the comparison, a match score generator module 160 may then generate a score, wherein the score indicates a similarity of interest in the same type of connection. If the match score reaches a particular, predetermined or dynamic threshold, the server 130 could communicate, via the network 120 and through the user devices 110 associated with each respective user, an introduction between the first and second user profiles.

In some embodiments, depending on the comparing, a separate match score may be generated for each profile. In this case, a comparison of the match scores would take place and a connection or introduction may occur between the two parties. In embodiments, based on the one or more match scores generated between two user profiles via the match score generation module 160, an option for an introduction may only be communicated to one of the users. For example, if the first user indicated a stronger preference or a closer form of connection toward the second user than did the second user toward the first, only the second user may receive an invitation to initiate a connection or introduction to the first user.

In embodiments, following the communication of an introduction to either the first, second or both of the first and second users, the server 130 may facilitate a chat feature or types of communication over network 120.

In embodiments, once an introduction has been successfully communicated by the server 130, the users may continue to chat up until the earlier selected date passes. For example, if the match occurs on May 20, based on a June 1 selection date, the first and second users may have an on-app chat or messaging service enabled until June 2. In this way, users are encouraged to connect at the prescribed date and if they are not able to connect or would not like to further continue the conversation outside of the app, they are unmatched and their chats removed. In some instances, a chat feature may be enabled for a longer time, in some cases indefinitely or until one or both parties to the chat remove themselves.

FIG. 2 depicts an example user interface to receive an input from a user, according to embodiments. In embodiments, user interface 200A-B may appear on a user device, such as a cellular phone, smart phone, tablet, wearable or other device. These devices may be the same or similar to those described at 110 in FIG. 1.

Shown here are two example interfaces the user may be prompted to engage with throughout their use of the application. The First, 200A is a depiction of the calendar interface. At this view, a usual calendar interface is shown. The display may be for a month, a week, a day, or any other time period. When presented with this display, a user may select one more dates (indicated by the boxes here). The selection is intended to reflect when they are interested and available in meeting up, for example, for a date. In other contexts, this could be for a business connection, networking event, mentoring session. In still other contexts, this could be availability and interest to meet up for a children's play date, babysitting, or other parent-focused connection. Other contexts could apply not specified here and these examples are merely illustrative and not intended to limit the application of the interface.

At 200B, a second interface is shown. Here, following the selection of a date, the system (as described herein, and particularly in FIG. 1) may identify a match for this user, based on a selection of a same date or dates. In some instances, this match may also be filtered through one or more limiting factors, to reduce the number of matches. For example, in a highly-populated area such as Los Angeles, the application may use factors such as geographic location, age, or other factors to “filter” profiles selecting the same date to only those within an particular geographic range (e.g., 5 mile radius) or age (e.g., only 5 years older or younger). In other contexts, these filters could include filtering by industry, experience, time of day availability, desired frequency of meet up (e.g., one-time connection or on-going) or other factors. The interface may show a video as described herein of the user. In instances, this video may be a brief introduction video, a short film of a personal interest, or another video. In some cases, the videos will be reviewed and approved by administrators before sharing; in other cases, the video content will be self-managed by the community.

FIG. 3 depicts an example flow of the system for connecting profiles in a networked environment, according to embodiments. The flow 300 begins at 301, when the system identifies a first value form a first user profile. For example a user may view an introduction video shared by a second user and indicate a strong relationship interest for the second user. The system will receive that indication and assign a particular first value to the first user's indication. At the same or a different time, at the second user may indicate a strong relationship interest for the first user, based on viewing the first user's introduction video. The system will receive this as a second value, capturing both the first user association as well as the relationship interest indication, as detailed at 303.

At 305, the system will then compare the first and second values. And, at 307, calculate a match score based on the comparison. Further details are shown in later figures outlining the specifics of the calculations. In this case, the score will indicate an alignment in both expressions of interest and type of interest (e.g., a relationship). Responsive to this calculation, the system will communicate, per 309, an introduction between the first user profile and the second user profile. The contents of the introduction and the method of introduction may vary as described herein or as may be relevant to the application.

FIG. 4 depicts a detailed example flow of the system for connecting profiles in a networked environment, according to embodiments. The flow in FIG. 4 may be an extension of the flow depicted in the earlier figures, for example FIG. 3. Process 400 begins when a system receives a date selection from the first user, per 401. As described herein, this may be from a traditional calendar graphic displayed on a user interface, or in another way. At 403, the system identifies the second user has selected the same date. Based on this identification, the system may then associate or pair the two profiles, per 405, indicating that the two users have selected a preference for and availability to meet up on at least one of the same dates.

At 407, responsive to the associating or pairing, the system may send for display, to the first user, videos of the second user. As described herein, these introduction videos may be short and simple video communications similar to those used on other social media sites or used instead of introductory photos as used on many other dating sites. At 409, the system may identify a first value from the first user profile. This value may indicate a particular types of attraction toward the introduction video clips viewed of the second user. A plurality of values may be submitted by the first user profile, which could be responsive to introductory videos displayed of several different users. These values may be the same or different values, indicate a same or different type of attraction or desired connection, respectively. At 411, the system may receive a second value from a second user profile. Like the first value received at 409, this value may indicate a type of attraction or desired connection with one or more users.

At 413, the first value and second value may be compared. At 415, a match score may be calculated. When used herein, the match score may reflect a particular type of matching or mutual interest level for which the two users profiles may be connected. More details of the calculation of this score are detailed herein, specifically when described in the algorithm visualization figure. At 417, the system may assign the first user profile to a first category, relative to the second user profile. This category may indicate the type of connection that is suitable for the first user relative to the second user, based on the calculation using the first and second submitted values.

At 419, an introduction may be communicated between the first and second user profiles based on the match score. The category may also be communicated, indicating which type of relationship is mutually desired. From there, the users may communicate to identify a location and more specifics of the meet up, as described herein.

FIG. 5 depicts a visualization of the algorithm 500 for weighting and connecting profiles in a networked environment, according to embodiments. At 501, the system receives an input. This input may be the same input as described herein, namely input associated with one or more user profiles responsive to viewing one or more profiles of other users. For ease of discussion, we will refer to the different types of input as different values. According to the particular value of the input, the system may determine a particular relationship “match”. The different initial sorting may occur according to a particular threshold or thresholds, for examples x>0 would result in a “company” characterization, per 503. In another example 0>x>0.5 would result in a “relationship” characterization, per 505, and so on. If the input, when compared, both resulted in the company characterization, 503, the two profiles may be ‘matched’ per 511, and an introduction would be made, indicating they had matched accordingly. Similarly, if the input 501 was compared and the values indicated both users were interested in a “sex only” relationship, per 507, the users would be matched, per 515, and an introduction would be made. In other embodiments, according to particular values of the input the system may determine a particular relationship “type” is desired. For example, if sex=0 and romance=0, the type of relationship is “friendship”. Similarly, “company” or “sex only” are simple categories that lead to a “match” or introduction, as described herein.

In the other two initial categories, relationship 505 and friends 509, an initial comparison of the input 501 values may indicate that the users are interested in a relationship or a friendship, respectively. In the case of the fourth category, “relationship”, 505, the algorithm takes another step and analyzes the input values to determine what type of romantic relationship they are interested in and the level of interest overall. The system would then perform mathematical calculations, illustrated as “basic math” 513, and from that they would either be grouped into one of two sub-categories: friends with benefits (FWB) romantic or sex-interest. As indicated in the figure, the input would be rated according to the FWB-romantic scale, 523, and the sex interest scale, 525. Essentially, the system determines, based on math, if the interest is “close enough” to justify an introduction or match. In some instances, this “close enough” determination may be a pre-configured value or range. In others, it may be dynamic and adjusted based on feedback, machine learning, or other user-specific or application-specific data that is collected and stored. According to the output of these value determinations (i.e., the match score), the profiles are matched and an indication of the type of mutually-desired connection may be communicated.

Similarly, when a comparison of the initial input 501 values landed the profiles in the friends 509 category, the system could then determine if the mutual interest was directed toward a playdate 517 category, which would indicate a preference to connect with children and likely in a child-friendly space or if the connection was rather directed toward a business connection 519. In either case, the profiles would be matched, per 521, and the match would be communicated to each user via the respective user profiles, with an indication of the type of mutually-desired connection for which they had been matched.

As shown in FIG. 6, computer system/server 12 in cloud computing node 10 is shown in the form of a general purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computer system/server 12 typically includes a variety of computer system readable media. Such media may be an available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be under-stood that although not shown, other hardware and/or soft-ware components could be used in conjunction with computer system/server 12. Examples, include, but are not limited to: microcode, device drivers, redundant processing units, external disk drive arrays, RAID systems, tape drives, and data archival storage systems, etc.

Referring now to FIG. 7, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Com-munity, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a wave-guide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flow-chart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service. Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, net-works, and other fundamental computing resources where the consumer is able to deploy and run arbitrary software, which can include operating systems and applications. The consumer does not manage or control the underlying cloud infrastructure but has control over operating systems, stor-age, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises. Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate.

For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A computer-implemented method for connecting two user profiles, the method comprising:
identifying a first value from a first user profile
identifying a second value from a second user profile
comparing, using an algorithm, the first value with the second value
determining, based on the comparing, a match score
communicating, based on the match score, an introduction between the first user profile and the second profile.

2. The method of claim 1, wherein the determining, based on the match score, comprises:
assigning, based on the first value and the second value, the first user profile to a first category.

3. The method of claim 1, further comprising, prior to the identifying the first value,
receiving, from a first user device associated with the first user profile, a first selection of a particular date,
identifying, from a second user device associated with the second user profile, a second selection of the particular date;
associating, based on the first selection and the second selection and the particular date, the first user profile and the second user profile.

4. The method of claim 1, further comprising, prior to the identifying the first value,
displaying, on the first user device associated with the first user profile, a video of the second user,
receiving, from the first user device, the first value from the first user profile.

5. The method of claim 1, further comprising:
receiving, from a first user, a set of one or more videos;
associating, with the first user profile, the set of one or more videos; and
causing, in response to the associating, a display of the set of one or more videos onto a second device associated with the second user.

6. The method of claim 1, wherein the first user profile comprises a plurality of videos, wherein the videos are under 10 seconds.

7. The method of claim 2, wherein the first category is a type of relationship.

8. The method of claim 7, wherein the type of relationship is a platonic friendship.

9. The method of claim 7, wherein the type of relationship is a child play date.

10. The method of claim 7, wherein the type of relationship is a vendor.

11. A computer system for connecting two user profiles, the method comprising:
at least one processor circuit having:
a profile generating module configured to:
identify a first value from a first user profile, and
identify a second value from a second user profile:
a match type comparison module configured to:
compare, using an algorithm, the first value with the second value; and
a match score generating module configured to:
determine, based on the comparing, a match score, and
communicate, based on the match score, an introduction between the first user profile and the second profile.

12. The computer system of claim 11, wherein the match score generating module is further configured to:
assign, based on the determining and the first value and the second value, the first user profile to a first category.

13. The computer system of claim 11, wherein the profile generating module is further configured to:
prior to the identifying the first value, receive, from a first user device associated with the first user profile, a first selection of a particular date,
identify, from a second user device associated with the second user profile, a second selection of the particular date; and
associate, based on the first selection and the second selection and the particular date, the first user profile and the second user profile.

14. The computer system of claim 11, wherein the profile generating module is further configured to:
prior to the identifying the first value,
display, on the first user device associated with the first user profile, a video of the second user, and
receive, from the first user device, the first value from the first user profile.

15. The computer system of claim 11, wherein the profile generating module is further configured to:
receive, from a first user, a set of one or more videos;
associate, with the first user profile, the set of one or more videos; and
cause, in response to the associating, a display of the set of one or more videos onto a second device associated with the second user.

16. The computer system of claim 12, wherein the first category is a type of relationship.

17. A computer program product for connecting profiles, the computer program product comprising a computer read-able storage medium having program instructions embodied therewith, wherein the computer readable storage medium is not a transitory signal per se, the program instructions executable by a computer processing circuit to cause the circuit to perform the method comprising:
identifying a first value from a first user profile
identifying a second value from a second user profile
comparing, using an algorithm, the first value with the second value
determining, based on the comparing, a match score
communicating, based on the match score, an introduction between the first user profile and the second profile.

18. The computer program product of claim 17, wherein the determining, based on the match score, comprises:
assigning, based on the first value and the second value, the first user profile to a first category.

19. The computer program product of claim 17, further comprising, prior to the identifying the first value,
receiving, from a first user device associated with the first user profile, a first selection of a particular date,
identifying, from a second user device associated with the second user profile, a second selection of the particular date;
associating, based on the first selection and the second selection and the particular date, the first user profile and the second user profile.

20. The computer program product of claim 17, further comprising, prior to the identifying the first value,
displaying, on the first user device associated with the first user profile, a video of the second user,
receiving, from the first user device, the first value from the first user profile.
